(19) United States
(12) Patent Application Publication
(10) Pub. No.: US 2013/0027432 A1
(43) Pub. Date: Jan. 31, 2013

(54) Method and System for Displaying Contact Status

(71) Applicants: Bin Chen, Shenzhen City (CN); Weiwen Xie, Shenzhen City (CN); Shundong Gao, Shenzhen City (CN)

(72) Inventors: Bin Chen, Shenzhen City (CN); Weiwen Xie, Shenzhen City (CN); Shundong Gao, Shenzhen City (CN)

(73) Assignee: TENCENT TECHNOLOGY (SHENZHEN) COMPANY LIMITED, Shenzhen City, Guangdong Province (CN)

(21) Appl. No.: 13/635,424

(22) PCT Filed: Mar. 1, 2011
(86) PCT No.: PCT/CN11/71424

§ 371 Date: Sep. 15, 2012

(30) Foreign Application Priority Data
May 20, 2010 (CN) 201010183862.4

(51) Int. Cl. G09G 5/34; G09G 5/00

(52) U.S. Cl. 345/649; 345/619

(57) ABSTRACT

A method and a system for displaying contact status are provided by this invention which adapts to instant communication field. The method includes the following steps: obtaining contact status information; determining the corresponding path information according to the obtained contact status information; constructing and displaying a vector picture for indicating the contact status according to the path information. Through this invention, the problem of a large amount of data storage caused by pre-storing the pictures corresponding to the contact status is avoided.

### FIELD OF THE INVENTION

The present invention relates to instant communication field, and more particularly to a method and a system for displaying contact status.

### BACKGROUND OF THE INVENTION

Instant Messaging (IM) tools develops to today, has been accepted by the majority of internet users, and becomes user essential software tools. The IM tools have been widely used not only for usual entertainment, but also for work. Therefore, users have higher demand for IM software's ease of use, stability, security and other aspects. In the current IM software, users are provided with such as resurfacing, replacing background image, and other personalized features. By continually tap the character displayed in the IM software, the availability and ease of use of IM software can be further improved.

In order to allows the user to visually informed of the current status of their contact, existing technology provides a method for displaying the contact status, summarized as follows: detecting the current status of the contact by the IM server, storing a corresponding relation between the contact status and pictures for indicating the contact status in the user system, when the contact status is obtained, obtaining the picture for indicating the contact status according to the stored corresponding relation between the contact status and the pictures for indicating the contact status, and displaying the contact status in the IM software though the obtained picture or directly displaying the contact status via text.

It can be seen from the above described method for displaying the contact status provided by the existing technology that, in the existing technology in order to display the contact status, large amounts of the pictures for reflecting the contact status need to be stored in advance, which will cause large amount of data storage.

### SUMMARY OF THE INVENTION

The embodiments of the present invention provide a method for displaying contact status, to avoid the problem of large amount of data storage caused by pre-storing the pictures corresponding to the contact status.

Technical solutions provided by embodiments of the present invention includes:

A method for displaying contact status, the method includes:

obtaining contact status information;

determining corresponding path information according to the obtained contact status information;

constructing and displaying a vector picture for indicating the contact status according to the path information.

Another purpose of the present invention is to provide a system for displaying contact status, the system includes:

status obtaining unit, for obtaining contact status information;

path information obtaining unit, for determining corresponding path information according to the obtained contact status information;

vector picture constructing unit, for constructing a vector picture for indicating the contact status according to the path information;

display unit, for displaying the vector picture constructed by the vector picture constructing unit.

In the embodiments of the present invention, by obtaining the contact status information, determining the corresponding path information according to the obtained contact status information, and constructing the vector picture for indicating the contact status according to the path information, the contact status can be displayed without pre-storing the pictures corresponding to the contact status. The problem of large amount of data storage caused by pre-storing the pictures corresponding to the contact status is avoided.

### BRIEF DESCRIPTION OF THE DRAWINGS

FIG. 1 is a flow chart of a method for displaying a contact status provided by a first embodiment of the present invention;

FIG. 2 is a flow chart of a method for displaying a contact status provided by a third embodiment of the present invention;

FIG. 3 is a flow chart of a method for displaying a contact status provided by a fifth embodiment of the present invention;

FIG. 4 is a flow chart of a method for displaying a contact status provided by a sixth embodiment of the present invention;

FIG. 5 is a flow chart of a method for displaying a contact status provided by a seventh embodiment of the present invention.

### DETAILED DESCRIPTION OF PREFERRED EMBODIMENTS

In embodiments of the present invention, corresponding path information is obtained according to contact status information, and a vector picture for displaying contact status is constructed according to the path information. It can be seen that, the embodiments of the present invention, unlike the existing method for displaying contact status, in order to display the contact status, pre-storing the pictures corresponding to the contact status, but dynamically constructed the vector picture for indicating the contact status.

Wherein, the contact status information refers to the information of the current status of the contact, includes but not limited to, game status, listen to music status, etc.

Preferably, in the embodiments of the present invention, when constructing the vector picture, a corresponding dynamic path algorithm can be obtained according to the contact status information, and a vector picture for indicating the contact status is output according to the dynamic path, specifically exemplified by the following embodiment 3 to embodiment 5.

To make the objective, the technical solutions and advantages of the present invention more apparently, embodiments of the present invention will be described in detail accompanying with figures as follows. It should be understood that the specific embodiments described herein is only to explain the present invention, not used to limit the present invention.

### Embodiment 1

FIG. 1 shows a flow chart of a method for displaying contact status provided by the embodiment of the present invention, specifically exemplified by follows:

In Step 101, contact status information is obtained. Wherein, the step of obtaining the contact status information is by interacting with a communication server for detecting contact status, such as an IM sever. IM server will be as an example to explain how to obtain the contact status information:

When the IM server detects a change of the contact status, the IM server sends status information to users related to the contact to tell the users the contact status of the corresponding contact. After receiving the status information sent by the IM server, the contact status information is obtained by analyzing the status information.

In Step 102, corresponding path information is determined according to the contact status information.

Wherein, the path information means a set of a sequence of points for constituting a target shape. In this embodiment, a vector picture for displaying contact status can be constructed according to a set of a sequence of points in the path information.

Preferably, in the embodiment of the present invention, a corresponding relation between the status information and the path information is stored in advance. Based on this, Step 102 specifically includes: matching the contact status information obtained in Step 101 and the status information in the corresponding relation between the status information and the path information stored in advance, and determining the path information corresponding to the contact status information obtained in Step 101.

In the embodiment of the present invention, a mapping table can be used to store the corresponding relation between the status information and the path information. Table 1.1 shows examples of the corresponding relation between the status information and the path information. Of course, the method for storing the corresponding relation between the status information and the path information is not limited to the shown method, and other methods also can be used but will not be described in detail here.

TABLE 1.1

| status information | path information |
|---|---|
| game status | Path 1 |
| listen to music status | Path 2 |
| . | . |
| . | . |
| . | . |
| Status N | Path N |

It can be seen from the Table 1.1 that when the status information is game status, the corresponding path information is Path1, and when the status information is listen to music status, the corresponding path information is Path2.

In Step 103, a vector picture for displaying contact status is constructed according to the path information and the vector picture is displayed.

Wherein, the specific process of constructing the vector picture according to the path information belongs to existing technology, and will not be described in detail here. Since the path information corresponds to the contact status information, the vector picture constructed according to the path information can accurately and intuitively display the contact status.

To be more specific to illustrate the method in FIG. 1, in following context, the method in FIG. 1 is further described by assuming the obtained status information in Step 101 is the game status or the listen to music status, as examples.

For example, if the status information obtained in Step 101 is game status, the path information obtained in Step 102 is the path information corresponding to the game status. In Step 103, the vector picture for displaying the contact in the game status (called game vector picture) is constructed and displayed according to the path information corresponding to the game status. Specifically, the vector picture constructed and displayed to display the game status according to the path information is a game vector picture.

If the status information obtained in Step 101 is the listen to music status, the path information obtained in Step 102 is the path information corresponding to the listen to music status. In Step 103, the vector picture for displaying the contact in the listen to music status (called listen to music vector picture) is constructed and displayed according to the path information corresponding to the listen to music status. Specifically, the vector picture constructed and displayed to display the listen to music status according to the path information is a music vector picture, such as a picture having a musical note.

It can be seen from above, in one embodiment of the present invention, after the contact status information being obtained, the corresponding path information can be determined according to the contact status information. According to the path information, the vector picture for displaying the contact status can be constructed and displayed, and the contact status can be accurately and intuitively displayed.

So far, the description of the first embodiment is complete.

### Embodiment 2

In practical applications, the status information in the first embodiment can be further subdivided. For example, when the contact is in the game status, the games may include a variety of different game categories, the game status accordingly, may includes a variety of more specific game status. For example, when the games are divided into puzzle games, shooting games, chess card games, etc., according to the use classification thereof, the corresponding game status can be divided into puzzle game status, shooting game status, chess card game status, etc. When the games are divided into Landlords game, upgrade games, chess games, etc. according to the name classification thereof, the corresponding game status can be divided into Landlords game status, the upgrade game status, the chess game status, etc. Of course, other game classification, also corresponds to a specific game status, but will not be described in detail here. Similarly, music may include a variety of different game categories, the listen to music status, accordingly, may include a variety of more specific listen to music status. For example, when the music is divided into light music, heavy metal music according to the melody, the listen to music status can be divided into listen to light music status, listen to heavy metal music status. Of course, other music classification, also corresponds to a specific listen to music status, but will not be described in detail here.

When the status information includes game status, listen to music status and so on, and the game status includes various game classification status and the listen to music status includes various music classification status, i.e. when the status information includes classification status information, the corresponding relation between the status information and the path information stored in advance in the first embodiment further includes the corresponding relation between the classification status information and the path information. Table 1.2 and Table 1.3 show two examples of the corresponding relation between the classification status information and the path information. Of course, the method for storing the corresponding relation between the classification status information and the path information is not limited to above displaying examples, other methods also can be used but will not be described in detail here.

TABLE 1.2

| status information | path information |
|---|---|
| game status classification 1 | Path 1 |
| game status classification 2 | Path 2 |
| listen to music status | Path 3 |
| classification 1 | |
| listen to music status | Path 4 |
| classification 2 | |

TABLE 1.3

| | |
|---|---|
| status information | path information |

| | | |
|---|---|---|
| game status | game status | Path 1 |
| | classification 1 | |
| | game status | Path 2 |
| | classification 2 | |
| listen to music | listen to music | Path 3 |
| status | status | |
| | classification 1 | |
| | listen to music | Path 4 |
| | status | |
| | classification 2 | |

In the embodiment of the present invention, when the status information is the game status, the specific game classification can be determined by further analyzing the game status of the contact, the corresponding path information can be determined according to the specific game classification. Hereafter, the vector picture for indicating the specific contact status can be constructed and displayed according to determined path information following the method described in the Step 103.

### Embodiment 3

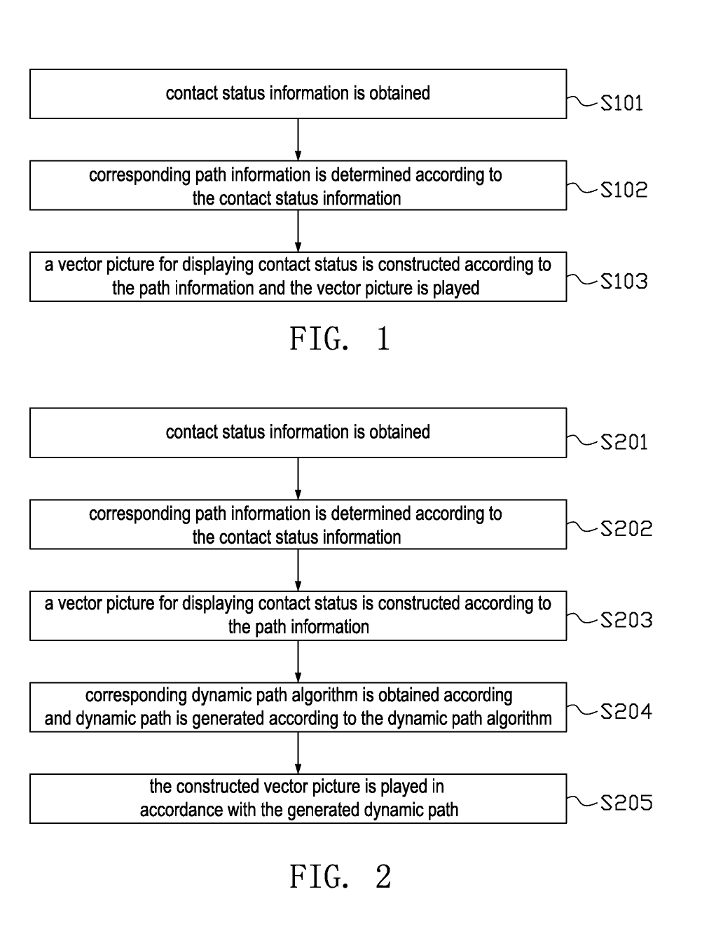

FIG. 2 shows a flow chart of a method for displaying contact status provided by the third embodiment of the present invention.

In Step 201, contact status information is obtained. The specific process thereof is same as described above and will not be described in detail here.

In Step 202, corresponding path information is determined according to the contact status information. The specific process thereof is same as described above and will not be described in detail here.

In Step 203, a vector picture for displaying contact status is constructed according to the path information and the vector picture is displayed. The specific process thereof is same as described above and will not be described in detail here.

In Step 204, corresponding dynamic path algorithm is obtained according to the contact status information and dynamic path is generated according to the dynamic path algorithm.

Wherein the specific process of obtaining corresponding dynamic path algorithm according to the contact status information includes following steps:

A corresponding relation between the status information and the dynamic path algorithm is stored in advance. The corresponding dynamic path algorithm can be obtained by matching the contact status information and the status information in the corresponding relation between the status information and the dynamic path algorithm stored in advance.

In the embodiment of the present invention, a mapping table can be used to store the corresponding relation between the status information and the dynamic path algorithm. Based on the description in the second embodiment, Table 1.4 and Table 1.5 show and example of a mapping table of the corresponding relation between the status information and the dynamic path algorithm, but the present invention is not limited to this example.

TABLE 1.4

| status information | dynamic path algorithm |
|---|---|
| game status classification 1 | dynamic path algorithm 1 |
| game status classification 2 | dynamic path algorithm 2 |
| listen to music status | dynamic path algorithm 3 |
| classification 1 | |
| listen to music status | dynamic path algorithm 4 |
| classification 2 | |

TABLE 1.5

| | |
|---|---|
| | dynamic path |
| status information | algorithm |

| | | |
|---|---|---|
| game status | game status | dynamic path |
| | classification 1 | algorithm 1 |
| | game status | dynamic path |
| | classification 2 | algorithm 2 |
| listen to | listen to music | dynamic path |
| music status | status | algorithm 3 |
| | classification 1 | |
| | listen to music | dynamic path |
| | status | algorithm 4 |
| | classification 2 | |

Wherein the dynamic path algorithm is defined by time point and corresponding deformation parameter. The corresponding deformation parameter of each time point includes one or any combination of scale, rotation angle and displacement.

Wherein, the scale refers to the scale relative to the scaling of the original size in the two-dimensional coordinate system (also known as the x-y coordinate system), i.e. the proportion compared with the original size. In the embodiment of the present invention, the scale includes transverse scale, i.e., the X scale, and the longitudinal scale, i.e., the Y scale.

The rotation angle refers to the clockwise rotation angle around a specified point within the two-dimensional coordinate system.

The displacement refers to Refers to the coordinate increment in the two-dimensional coordinate system relative to the original location, including transverse displacement (X) and longitudinal displacement (Y).

Preferably, in the embodiment of the present invention, the deformation parameter in the dynamic path algorithm, such as the change value of scale, rotation angle and displacement, is set according to the property of the current status. For example, when the contact status is listen to music status, the value of scale, rotation angle and displacement in dynamic path algorithm can be set according to the musical note, melody, bat rate, music classification (such as pop music, classical music, and opera and so on).

In the embodiment, different dynamic path algorithms for generating various dynamic paths are stored in advance. Table 1.6 shows an example of the dynamic path algorithm provided by the embodiment of the present invention, but the present invention is not limited to this example.

TABLE 1.6

| Time (ms) | Angle (degree) | X | Y | Scale X | Scale Y |
|---|---|---|---|---|---|
| 0 | −11.556 | 0 | 0 | 1 | 1 |
| 500 | | −11.046 | −11.383 | | |
| 1000 | 120 | −22.206 | −15.167 | 0.527 | 0.527 |

In the dynamic path algorithm shown in the Table 1.6, when the time point is 0 ms, the rotation angle of the object is −11.556, the displacement in x direction is 0, the displacement in y direction is 0, the scale in x direction is 1, and the scale in y direction is 1. When the time point is 500 ms, the rotation angle of the object is blank value, i.e. is not specified, the displacement in x direction is −11.046, the displacement in y direction is −11.383, the transverse scale and the longitudinal scale of the object are blank value, i.e., is not specified. When the time point is 100 ms, the rotation angle of the object is 120 degrees, the displacement in x direction of the object is −22.206, the displacement in y direction is −15.167, the scale of the object in x direction is 0.527, and the scale in y direction is 0.527.

It can be seen from the dynamic path algorithm mentioned above, different dynamic path algorithm can obtain different dynamic path.

Wherein, generating dynamic path according to dynamic path algorithm includes: calculating the value of deformation parameter in per time unit according to the time point in the dynamic path algorithm and the deformation parameter corresponding to time point, and generating dynamic path. The specific process thereof includes the following steps:

A. taking an initial time point in the dynamic path algorithm as a first time point;

B. for each deformation parameter at the first time point, calculating change value of the deformation parameter per time unit using the default path calculation formula, according to the value of the deformation parameter at the first time point and the value of the deformation parameter at a second time point, wherein the time unit is consisting of the first time point and the second time point.

Wherein, the second time point is a time point in the dynamic path algorithm which is after the first time point and the deformation parameter thereof is not a default blank value.

In the embodiment, the default path calculation formula can be a linear transform formula, a sine transform formula, or a parabola transform formula. Of course, other transform formulas provided by the existing technology also can be used, but will not be described in detail here. Wherein,

the linear transform formula is:

v=(VM−V0)/(TM−T0)*(t−T0)+V0;

the sine transform formula is:

v=(VM−V0)*Sin a(π/2*(t−T0)/(TM−T0))+V0;

the parabola transform formula is:

v=(t−T0)*(t−T0)*(VM−V0)/((TM−T0)*TM−T0))+V0.

Wherein, V0 is the value of the deformation parameter at the first time point, VM is the value of the deformation parameter (same as the deformation parameter at the first time point) at the second time point, TM is the second time point, T0 is the first time point, t is a time point between T0 and TM, v is the value of the deformation parameter at a time point t, and Sin a( ) is a Sine function.

In following context, each deformation parameter will be analyzed by assuming the default parameter path calculation formula is the linear transform formula, as examples. Other cases, such as the default parameter path calculation formula is the sine transform formula or the parabola transform formula etc. having similar principles, will not be described in detail here.

As an example, the value of the transverse scale per time unit is calculated by the default parameter path calculation formula according to the transverse scale at the first time point and the transverse scale at the second time point. Wherein, the second time point is a time point in the dynamic path algorithm which is after the first time point and the transverse scale thereof is not a default blank value. When the default parameter path calculation formula is the linear transform formula:

ScaleX_{—}v=(ScaleX2−ScaleX1)/(T2−T1)*(t−T1)+ScaleX1,

wherein ScaleX1 is the transverse scale at the first time point, ScaleX2 is the transverse scale at the second time point, t is a time point between T1 and T2, ScaleX_v is the transverse scale at the time point t, T1 is the first time point, T2 is the second time point.

As an example, the value of the longitudinal scale per time unit is calculated by the default parameter path calculation formula according to the longitudinal scale at the first time point and the longitudinal scale at the second time point. Wherein, the second time point is a time point in the dynamic path algorithm which is after the first time point and the longitudinal scale thereof is not a default blank value. When the default parameter path calculation formula is the linear transform formula:

ScaleY_{—}v=(ScaleY2−ScaleY1)/(T2−T1)*(t−T1)+ScaleY1,

wherein ScaleY1 is the longitudinal scale at the first time point, ScaleY2 is the longitudinal scale at the second time point, t is a time point between T1 and T2, ScaleY_v is the longitudinal scale at the time point t, T1 is the first time point, and T2 is the second time point.

As an example, the value of the rotation angle per time unit is calculated by the default parameter path calculation formula according to the rotation angle at the first time point and the rotation angle at the second time point. Wherein, the second time point is a time point in the dynamic path algorithm which is after the first time point and the rotation angle thereof is not a default blank value. When the default parameter path calculation formula is the linear transform formula:

Angle_{—}v=(Angle2−Angle1)/(T2−T1)*(t−T1)+Angle1,

wherein, Angle1 is the rotation angle at the first time point, Angle2 is the rotation angle at the second time point, t is a time point between T1 and T2, Angle_v is the rotation angle at the time point t, T1 is the first time point, and T2 is the second time point.

As an example, the value of the transverse displacement per time unit is calculated by the default parameter path calculation formula according to the transverse displacement at the first time point and the transverse displacement at the second time point. Wherein, the second time point is a time point in the dynamic path algorithm which is after the first time point and the transverse displacement thereof is not a default blank value. When the default parameter path calculation formula is the linear transform formula:

X_{—}v=(X2−X1)/(T2−T1)*(t−T1)+X1,

wherein X1 is the transverse displacement at the first time point, X2 is the transverse displacement at the second time point, t is a time point between T1 and T2, X_v is the transverse displacement at the time point t, T1 is the first time point, and T2 is the second time point.

As an example, the value of the longitudinal displacement per time unit is calculated by the default parameter path calculation formula according to the longitudinal displacement at the first time point and the longitudinal displacement at the second time point. Wherein, the second time point is a time point in the dynamic path algorithm which is after the first time point and the longitudinal displacement thereof is not a default blank value. When the default parameter path calculation formula is the linear transform formula:

Y_{—}v=(Y2−Y1)/(T2−T1)*(t−T1)+Y1,

wherein, Y1 is the longitudinal displacement at the first time point, Y2 is the longitudinal displacement at the second time point, t is a time point between T1 and T2, Y_v is the longitudinal displacement at the time point t, T1 is the first time point, and T2 is the second time point.

C. taking the second time point as the first time point, and returning to Step B.

In the embodiment of the present invention, Steps B to C are repeated until all time points in the dynamic path algorithm are calculated.

The dynamic path algorithm shown in the Table 1.6 will be taken as an example to illustrate a specific process of calculating the scale, the rotation angle and the displacement of an object per time unit using the above mentioned path calculation formula and generating a dynamic path:

The transverse scale per time unit is calculated as follows:

An initial time point 0 ms is taken as the first time point, and the transverse scale thereof is 1.

The transverse scale is calculated by the default path calculation formula according to the transverse scale at the first time point and the transverse scale at the second time point.

Since time point 1000 ms is a first time point which is after the first time point 0 ms and the transverse scale thereof is 0.527, not a default blank value, the transverse scale of any time point between 0 ms to 1000 ms is ScaleX_v, ScaleX_v=(0.527−1)/1000×(t−0)+1=−0.473/1000×t+1=1−0.000473t. In other words, during 0 ms to 1000 ms period of time, the transverse scale of the object at any time point is changed into 1-0.000473t, when 1000 ms is reached, the size of the object is transverse narrowed from the original size to 0.527.

The second time point 1000 ms is taken as the first time point. Since there is no time point after the time point 1000 ms in the dynamic path algorithm, the calculating is over.

The rotation angle per time unit is calculated as follows:

The initial time point 0 ms is taken as the first time point, the rotation angle thereof is −11.556.

The rotation angle is calculated by the default path calculation formula according the rotation angle at the first time point and the rotation angle at the second time point.

Since time point 1000 ms is a first time point which is after the first time point 0 ms and the rotation angle thereof is 120, not a default blank value, the rotation angle of any time point between 0 ms to 1000 ms is Angle_v,

Angle_v=(120−(−11.556))/1000*(t−0)+(−11.556)=131.556/1000*t−11.556=0.131556*t−11.556. In other words, during 0 ms to 1000 ms period of time, the rotation angle of the object at any time point is changed into 0.131556*t−11.556, when 1000 ms is reached, the rotation angle of the object is changed from −11.556 degrees at 0 ms to 120 degrees.

The second time point 1000 ms is taken as the first time point. Since there is no time point after the time point 1000 ms in the dynamic path algorithm, the calculating is over.

The transverse displacement per time unit is calculated as follows:

The initial time point 0 ms is taken as the first time point, and the transverse displacement thereof is 0.

The transverse displacement is calculated by the default path calculation formula according to the transverse displacement at the first time point and the transverse displacement at the second time point.

Since time point 500 ms is a first time point which is after the first time point 0 ms and the transverse displacement thereof is −11.046, not a default blank value, the calculating formula of the transverse displacement per time unit is:

X_v=(−11.046−0)/(500−0)*(t−0)+0=(−11.046)/500*t=−0.022092*t. In other words, during 0 ms to 500 ms period of time, the transverse displacement of the object at any time point is changed into −0.022092*t, when 500 ms is reached, the object moves left from 0 at 0 ms to −11.046.

The second time point 500 ms is taken as the first time point, and the transverse displacement thereof is −11.046. The transverse displacement per time unit is calculated by the default path calculation formula according the transverse displacement at the first time point and the transverse displacement at the second time point.

Since time point 1000 ms is a first time point which is after the first time point 500 ms and the transverse displacement thereof is −22.206, not a default blank value, the transverse displacement per time unit is X_v, and X_v=(−22.206−(−11.046))/(1000-500)*(t−500)+(−11.046)=(−11.16)/500*(t−500)−11.046=−0.02232*(t−500)−11.046. In other words, during 500 ms to 1000 ms period of time, the transverse displacement of the object at any time point is changed into −0.02232*(t−500)−11.046, when 1000 ms is reached, the object moves left from −11.046 to −22.206.

The second time point 1000 ms is taken as the first time point. Since there is no time point after the time point 1000 ms in the dynamic path algorithm, the calculating is over.

In Step 205, the constructed vector picture is played in accordance with the generated dynamic path.

For example, the constructed vector picture is a music vector picture, such as a musical not, the dynamic path is generated by the dynamic path algorithm shown in Table 1.6, it can be seen from the description of the dynamic path, during 1000 ms, the music vector picture first appears at the initial position, then moves left, gradually reduced at the same time, and gradually rotates clockwise.

Step 204 and Step 205 is specific process to show the constructed vector picture.

It can be seen that, in the Embodiment 3, different dynamic path can be obtained by different dynamic path algorithm, thereby different animation effect can be achieved.

### Embodiment 4

In order to show the contact status vividly, in the embodiment of the present invention, the contact status information can correspond to the at least two different path information. When constructing the vector picture according to the path information, the vector picture for indicating the current contact status respectively according to each of the path information. For example, when the contact status is the music status, two vector picture, such as a musical note vector picture and an earphone vector picture, can be constructed respectively according to the two path information in accordance with the music status.

Wherein, when the contact status information corresponds to at least two different path information, each path information can use a same dynamic path algorithm to generate same or different dynamic path corresponding to each path information, or each path information can use a different dynamic path algorithm to generate the dynamic path corresponding to each path information. As examples:

When the path information corresponding to the contact status information includes Path1 and Path2, Path1 and Path2 can use a same dynamic path algorithm (as shown in the Table 1.6) to generate same or different dynamic path, or use different dynamic path algorithm to generate the dynamic path. Using different dynamic path algorithm to generate the dynamic path will be taken as an example to explain:

When the contact status information is the music status, the path information obtained according the music status includes the path information of the musical note and the path information of the earphone, the vector picture for indicating the musical note is constructed according to the oath information of the musical note (called musical note picture), and the vector picture for indicating the earphone is constructed according to the oath information of the earphone (called earphone picture). When calculating the dynamic path of the musical note picture, the dynamic path algorithm shown in the Table 1.6 is applied, and when calculating the dynamic path of the earphone picture, the dynamic path algorithm shown in the Table 1.7 is applied. And then, the musical note picture and the earphone picture play in accordance with their respective dynamic path. In operation, Grid (a grid region can define rows and columns flexible, the equivalent of a container) is applied to describe the picture area, to display the contact's picture in picture controllers, and to arrange the picture controllers therein. Mouse events are listened on the Grid. When listening to the mouse hover event, the earphone picture starts to be played in accordance with the dynamic path of the earphone picture so as to achieve the animation effect of shaking head.

TABLE 1.7

| Time (ms) | Angle (degree) | X |
|---|---|---|
| 0 | 0 | 0 |
| 200 | −4 | −3 |
| 400 | 0 | 0 |
| 600 | 4 | 3 |
| 800 | 0 | 0 |

### Embodiment 5

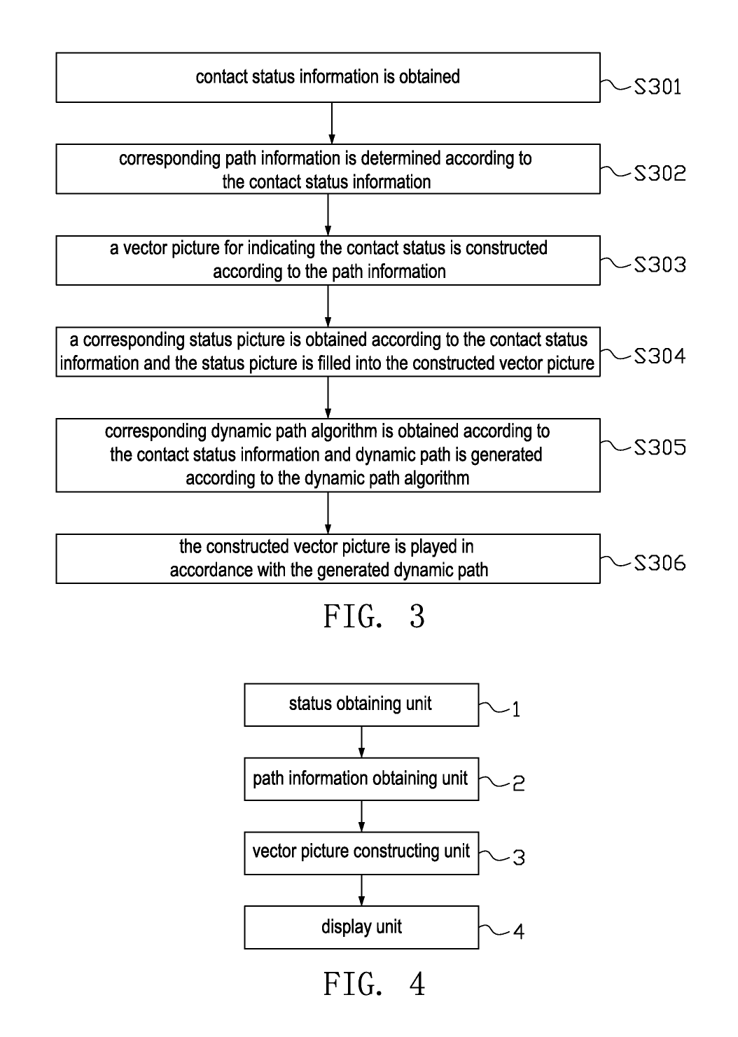

FIG. 3 shows a flow chart of a method for displaying contact status provided by the fifth embodiment of the present invention. The method will be described as follows:

In Step 301, contact status information is obtained. The specific process thereof is same as described above and will not be described in detail here.

In Step 302, corresponding path information is determined according to the contact status information. The specific process thereof is same as described above and will not be described in detail here.

In Step 303, a vector picture for indicating the contact status is constructed according to the path information. The specific process thereof is same as described above and will not be described in detail here.

In Step 304, a corresponding status picture is obtained according to the contact status information and the status picture is filled into the constructed vector picture.

Wherein, the status picture refers to an intercepted icon of the current contact status. For example, when the contact is playing game, the status picture is an intercepted icon of the game which the contact is playing at that moment, or a picture corresponding to the contact status information stored in advance. When the contact is playing the game, the status picture is the picture stored in advance and the picture corresponds to the game which the contact is playing at that moment.

In the embodiment of the present invention, although the vector picture for indicating the contact status can be constructed according to the path information corresponding to the contact status information, in order to display the contact status more vividly, the status picture according to the contact status information can be obtained, and the status picture can be filled into the constructed vector picture. For example, the status picture can be filled into the vector picture as background, so as to the contact status can be displayed more vividly. As examples:

When the contact status information is the game status, the game icon (game picture) is obtained, and the game icon is filled into the game vector picture constructed by the path information according to the game status.

Of course, in order to achieve animation effects, the embodiment further includes Step 305 and Step 306. The Step 305 and Step 306 are same as the Step 204 and Step 205 shown in the FIG. 2, so will not be described in detail here.

### Embodiment 6

FIG. 4 shows the structure of a system for outputting contact status of this invention, and in order to facilitate the description, only shows the relevant part of the embodiment of the present invention.

The system can be adapted in IM tools, and so on, can be implemented in software unit, hardware unit, or soft-hardware compact unit, also can be integrated into the IM tools as an independent pendant and implemented in the applications of IM tool. Wherein:

A status obtaining unit 1 is configured to obtain contact status information.

In the embodiment of the present invention, when the IM server detects change of the contact status, the IM server sends status information to users related to the contact to tell the users the contact status of the corresponding contact. After receiving the status information sent by the IM server, the contact status information is obtained by analyzing the status information. Wherein the contact status information means the current status information of the contact, includes, but not limited to game status, listen to music status, and so on.

A path information obtaining unit 2 is configured to determine corresponding path information according to the contact status information obtained by the status obtaining unit 2.

In the embodiment of the present invention, the corresponding relation between the status information and the path information is stored in advance. The path information according to the contact status information is determined by matching the contact status information with the status information in the corresponding relation between the status information and the path information stored in advance.

Preferably, because game and music may includes a variety of different game categories and music categories, the contact status information includes game status and listen to music status etc., according to different classification of game, the game status may includes different game classification status, music includes a variety of different music classification status, the corresponding relation between the status information and the path information stored in advance. The path information corresponding to the contact status information can be obtained by matching the contact status information and the status information in the corresponding relation between the status information and the path information stored in advance.

A vector picture constructing unit 3 is configured to construct the vector picture for indicating the contact status according to the path information obtained by the path information obtaining unit 2.

Because the path information corresponds to the contact status information, the vector picture constructed according the path information can be adapted for indicating contact status.

A display unit 4 is configured to display the vector picture constructed by the vector picture constructing unit 3. It can be seen that, in the embodiment of the present invention, after obtaining the contact status information, the corresponding path information can be obtained according to contact status information, the vector picture for indicating the contact status can be constructed according to the path information as to achieve the purpose of displaying the contact status.

### Embodiment 7

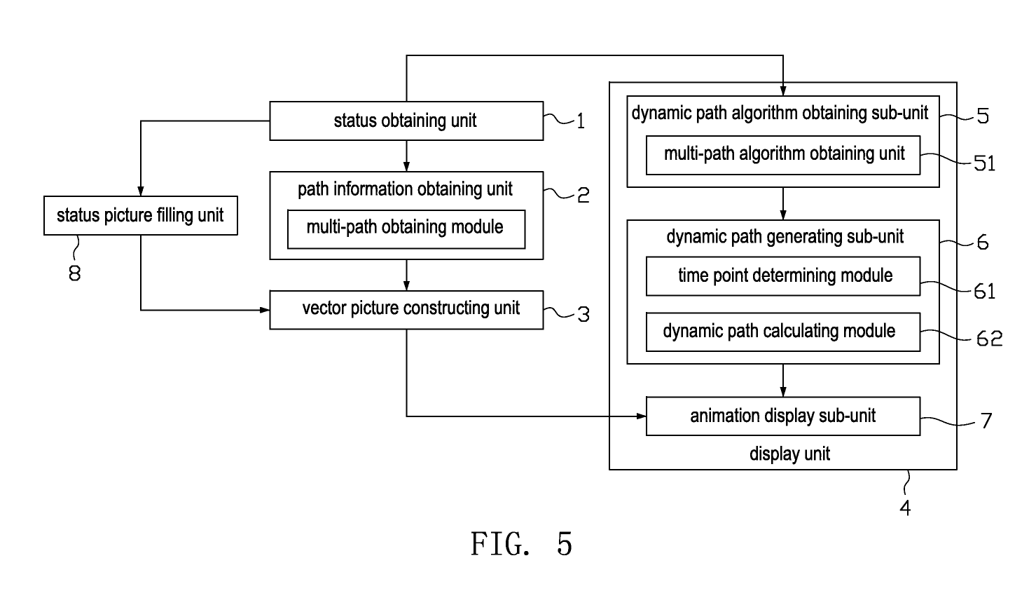

FIG. 5 shows the structure of a system for outputting contact status provided by the seventh embodiment of the present invention, and in order to facilitate the description, only shows the relevant part of the embodiment of the present invention. On the basis of the system shown in FIG. 4, the system segments include the following components:

A dynamic path algorithm obtaining sub-unit 5 is configured to obtain the corresponding dynamic path algorithm 5 according to the contact status information obtained by the status obtaining unit 1.

In the embodiment of the present invention, the corresponding relation between the status information and the dynamic path algorithm is stored in advance, the dynamic path algorithm corresponding to the contact status information can be obtained by matching the contact status information and the status information in the corresponding relation between the status information and the dynamic path algorithm stored in advance.

Wherein, the dynamic path algorithm is defined by the time point and a deformation parameter corresponding to the time point, wherein the deformation parameter of the time point includes one or multiple combinations of scale, rotation angle, and displacement.

Wherein, the scale refers to the scale relative to the scaling of the original size in the two-dimensional coordinate system (also known as the x-y coordinate system). In the embodiment of the present invention, the scale includes transverse scale, i.e., the X scale, and the longitudinal scale, i.e., the Y scale.

The rotation angle refers to the clockwise rotation angle around a specified point within the two-dimensional coordinate system.

The displacement refers to refers to the coordinate increment in the two-dimensional coordinate system relative to the original location, including transverse displacement (X) and longitudinal displacement (Y).

In the embodiment of the present invention, the scale of the object, the rotation angle of the object, and the displacement of the object is set according to the property of the contact status.

A dynamic path generating sub-unit 6 is configured to generate dynamic path according to the dynamic path algorithm obtained by the dynamic path algorithm obtaining sub-unit 5. The dynamic path generating sub-unit 6 includes a time point determining module 61, a dynamic path calculating module 62. Wherein:

The time point determining module 61 determines the first time point and the second time point in the dynamic path algorithm.

In the embodiment of the present invention, before generating the dynamic path, the time point determining module 61 determines the initial time point in the dynamic path algorithm as the first time point, and the first time point is constantly updated during the calculation. The second time point refers to a time point in the dynamic path algorithm which is after the first time point and the deformation parameter thereof is not a default blank value. That means, when calculating the transverse scale per time unit, the second time point refers to a time point in the dynamic path algorithm which is after the first time point and the transverse scale thereof is not a default blank value. When calculating the rotation angle per time unit, the second time point refers to a time point in the dynamic path algorithm which is after the first time point and the rotation angle thereof is not a default blank value. When calculating the transverse displacement per time unit, the second time point refers to a time point in the dynamic path algorithm which is after the first time point and the transverse displacement thereof is not a default blank value. When calculating the longitudinal displacement per time unit, the second time point refers to a time point in the dynamic path algorithm which is after the first time point and the longitudinal displacement thereof is not a default blank value.

A dynamic path calculating module 62 is configured to calculate a change value of each deformation parameter in a time unit consisting of two time points using a default parameter path calculation formula according to value of each deformation parameter at the first time point and value of each deformation parameter at the second time point, wherein the second time point is a time point in the dynamic path algorithm which is after the first time point and the deformation parameter thereof is not a default blank value.

Wherein, the default path calculation formula can be a linear transform formula, a sine transform formula, or a parabola transform formula. Of course, other transform formulas provided by the existing technology also can be used, but will not be described in detail here, wherein:

the linear transform formula is:

v=(VM−V0)/(TM−T0)*(t−T0)+V0;

the sine transform formula is:

v=(VM−V0)*Sin a(π/2*(t−T0)/(TM−T0))+V0;

the parabola transform formula is:

v=(t−T0)*(t−T0)*(VM−V0)/((TM−T0)*TM−T0))+V0.

Wherein VM is the value of the deformation parameter at the second time point, V0 is the value of the deformation parameter at the first time point, TM is the second time point, T0 is the first time point, t is a time point between T0 and TM, v is the value of the deformation parameter at the time point t, Sin a( ) is a sine function.

In the embodiment of the present invention, the dynamic path calculating module 62 includes a transverse scale calculating module, a longitudinal scale calculating module, a rotation angle calculating module, a transverse displacement calculating module, and a longitudinal displacement calculating module. Wherein:

The transverse scale calculating module is configured to calculate a change value of the transverse scale in the time unit consisting of the first time point and the second time point using the default parameter path calculation formula according to the value of the transverse scale at the first time point and the value of the transverse scale at the second time point.

The longitudinal scale calculating module is configured to calculate a change value of the longitudinal scale in the time unit consisting of the first time point and the second time point using the default parameter path calculation formula according to the value of the longitudinal scale at the first time point and the value of the longitudinal scale at the second time point.

The rotation angle calculating module is configured to calculate a change value of the rotation angle in the time unit consisting of the first time point and the second time point using the default parameter path calculation formula according to the value of the rotation angle at the first time point and the value of the rotation angle at the second time point.

The transverse displacement calculating module is configured to calculate a change value of the transverse displacement in the time unit consisting of the first time point and the second time point using the default parameter path calculation formula according to the value of the transverse displacement at the first time point and the value of the transverse displacement at the second time point.

The longitudinal displacement calculating module is configured to calculate a change value of the longitudinal displacement in the time unit consisting of the first time point and the second time point using the default parameter path calculation formula according to the value of the longitudinal displacement at the first time point and the value of the longitudinal displacement at the second time point.

After the transverse scale, the longitudinal scale, the rotation angle, the transverse displacement, the longitudinal displacement has been calculated by the dynamic path calculating module 62, the time point determining module takes the second time point as the first time point and re-perform the above operation.

Animation play sub-unit 7 is configured to play the vector picture constructed by the vector picture constructing unit 3 according the dynamic path generated by the dynamic path generating sub-unit 6.

In the embodiment of the present invention, since the constructed vector picture is played according to the generated dynamic path, the contact status can be dynamically displayed without pre-storing multiple pictures.

In another embodiment of the present invention, the contact status information can correspond to at least two different path information, now, the path information obtaining unit 2 further includes a multi-path obtaining module 21. The multi-path obtaining module 21 is configured to obtain the corresponding at least two different path information according to the contact status information obtained by the multi-path obtaining module 21 multi-path obtaining module 21 status obtaining unit 1. The vector picture constructing unit 3 generates the vector picture for indicating the current contact status respectively according to each path information obtained by the multi-path obtaining module 21.

When the contact status information corresponds to the at least two different path information, each path information can use same dynamic path algorithm to generate same or different dynamic paths, each path information also can use different dynamic path algorithm to generate the dynamic path. At this moment, the dynamic path algorithm obtaining sub-unit 5 includes multi-path algorithm obtaining unit 51. The multi-path algorithm obtaining unit 51 obtains the same dynamic path algorithm set for each path information to generate same or different dynamic paths set for each path information to generate the dynamic path corresponding to each path information. When the path information corresponding to contact status information includes Path1 and Path2, the multi-path algorithm obtaining unit 51 obtains the dynamic path algorithm corresponding to the Path1, and the dynamic path algorithm corresponding to the Path2. The dynamic path generating sub-unit 6 respectively generates a dynamic path according to each dynamic path algorithm obtained by the multi-path algorithm obtaining unit 51.

In another embodiment of the present invention, the system further includes a status picture filling unit 8. The status picture filling unit 8 obtains the corresponding status picture according to the contact status information obtained by the status obtaining unit 1 and fills the status picture into the vector picture constructed by the vector picture constructing unit 3.

In the embodiment of the present invention, by filling the status picture is filled into the constructed vector picture, so as to the contact status can be displayed more vividly.

It can be understood that all or part of the technique solutions provided by the above embodiments can be achieved by programming, and the program can be stored in a computer readable storing medium such as, hard disk drives, compact disks, or soft disk drives. The program is applied to perform the following steps:

In the embodiments of the present invention, by obtaining the contact status information, determining the corresponding path information according to the obtained contact status information, and constructing the vector picture for indicating the contact status according to the path information, the contact status can be displayed without pre-storing the pictures corresponding to the contact status. The problem of large amount of data storage caused by pre-storing the pictures corresponding to the contact status is avoided.

The above descriptions are only preferred embodiments of the present invention, and are not intended to limit the present invention. Any amendments, replacement and modification made to the above embodiments under the spirit and principle of the present invention should be included in the scope of the present invention.

1. A method for displaying contact status, comprising:
obtaining contact status information;
determining corresponding path information according to the obtained contact status information; and
constructing and displaying a vector picture for indicating the contact status according to the path information.

2. The method as claimed in claim 1, wherein the step of obtaining the contact status information comprises:
obtaining the contact status information by interacting with a communication server adapted for detecting the contact status.

3. The method as claimed in claim 1, wherein before implementation of the method, further comprises: storing a corresponding relation between the contact status information and the path information in advance;
the step of determining the corresponding path information according to the obtained contact status information comprises: determining the path information corresponding to the obtained contact status information by matching the corresponding relation.

4. The method as claimed in claim 1, wherein the step of displaying the vector picture for indicating the contact status comprises:
obtaining a corresponding dynamic path algorithm according to the contact status information, and generating a dynamic path according to the dynamic path algorithm; and
playing the constructed vector picture according to the generated dynamic path.

5. The method as claimed in claim 4, wherein the dynamic path algorithm is defined by a time point and a deformation parameter corresponding to the time point, the deformation parameter of the time point comprises at least one of scale, rotation angle, and displacement, the scale comprises transverse scale and/or longitudinal scale, the displacement comprises transverse displacement and/or longitudinal displacement;
the step of generating the dynamic path according to the dynamic path algorithm comprises:
A. taking an initial time point as a first time point in dynamic path algorithm;
B. calculating a change value of each deformation parameter in a time unit consisting of two time points using a default parameter path calculation formula according to a value of each deformation parameter at the first time point and a value of each deformation parameter at a second time point, wherein the second time point is a time point in the dynamic path algorithm which is after the first time point and the deformation parameter thereof is not a default blank value; and
C. if a time point after the second time point in the dynamic path algorithm existing, taking the second time point as the first time point, returning to step B, otherwise, ending the process.

6. The method as claimed in claim 1, wherein if at least two different path information are determined according to the contact status information, the step of constructing the vector picture for indicating the contact status according to the path information comprises:
constructing a vector picture for indicating the contact status respectively according to each path information.

7. The method as claimed in claim 6, wherein the different path information corresponds to same dynamic path algorithms or different dynamic path algorithms.

8. The method as claimed in claim 1, wherein after constructing the vector picture for indicating the contact status according to the path information and before displaying the vector picture further comprising:
obtaining a corresponding status picture according to the contact status information, and filling the status picture into the constructed vector picture.

9. A system for displaying a contact status, comprising:
a status obtaining unit, configured to obtain contact status information;
a path information obtaining unit, configured to determine corresponding path information according to the obtained contact status information;
a vector picture constructing unit, configured to construct a vector picture for indicating the contact status according to the path information; and
a display unit, configured to display the vector picture constructed by the vector picture constructing unit.

10. The system as claimed in claim 9, wherein the status obtaining unit further configured to obtain the contact status information by interacting with a communication server adapted for detecting the contact status.

11. The system as claimed in claim 9, wherein the display unit comprises:
a dynamic path algorithm obtaining sub-unit, configured to obtain a corresponding dynamic path algorithm according to the contact status information, and generate a dynamic path according to the dynamic path algorithm;
a dynamic path generating sub-unit, configured to generate the dynamic path by the dynamic path algorithm obtained by the dynamic path algorithm obtaining sub-unit; and
an animation play sub-unit, configured to play the vector picture constructed by the vector picture constructing unit according to the dynamic path generated by the dynamic path generating sub-unit.

12. The system as claimed in claim 9, wherein the dynamic path algorithm is defined by a time point and a deformation parameter corresponding to the time point, the deformation parameter of the time point comprises at least one of scale, rotation angle, and displacement, the scale comprises transverse scale and/or longitudinal scale, the displacement comprises transverse displacement and/or longitudinal displacement;
the dynamic path generating sub-unit comprises:
a time point determining module, configured to determine a first time point and a second time point in the dynamic path algorithm; and
a dynamic path calculating module, configured to calculate a change value of each deformation parameter in a time unit consisting of two time points using a default parameter path calculation formula according to a value of each deformation parameter at the first time point and a value of each deformation parameter at the second time point, wherein the second time point is a time point in the dynamic path algorithm which is after the first time point and the deformation parameter thereof is not a default blank value.

13. The system as claimed in claim 9, wherein if the path information obtaining unit further configured to determine at least two different path information according to the contact status information, the vector picture constructing unit further configured to construct a vector picture for indicating the contact status respectively according to each path information.

14. The system as claimed in claim 9, wherein the system comprises:
a status picture filling unit, configured to obtain corresponding status picture according to the contact status information, and filling the status picture into the vector picture constructed by the vector picture constructing unit.

15. The method as claimed in claim 2, wherein if at least two different path information are determined according to the contact status information, the step of constructing the vector picture for indicating the contact status according to the path information comprises:
constructing a vector picture for indicating the contact status respectively according to each path information.

16. The method as claimed in claim 3, wherein if at least two different path information are determined according to the contact status information, the step of constructing the vector picture for indicating the contact status according to the path information comprises:
constructing a vector picture for indicating the contact status respectively according to each path information.

17. The method as claimed in claim 4, wherein if at least two different path information are determined according to the contact status information, the step of constructing the vector picture for indicating the contact status according to the path information comprises:
constructing a vector picture for indicating the contact status respectively according to each path information.

18. The method as claimed in claim 5, wherein if at least two different path information are determined according to the contact status information, the step of constructing the vector picture for indicating the contact status according to the path information comprises:
constructing a vector picture for indicating the contact status respectively according to each path information.
